(19) United States
(12) Patent Application Publication
(10) Pub. No.: US 2021/0187951 A1
(43) Pub. Date: Jun. 24, 2021

(54) SPITTOON CARTRIDGE FOR A PRINTING DEVICE

(71) Applicant: Hewlett-Packard Development Company, L.P., Spring, TX (US)

(72) Inventors: Santiago Forcada Pardo, Sant Cugat del Valles (ES); Alejandro Mielgo Barba, Sant Cugat del Valles (ES); Jeffrey Thielman, Sant Cugat del Valles (ES)

(21) Appl. No.: 17/273,433

(22) PCT Filed: Dec. 11, 2018
(86) PCT No.: PCT/US2018/064995

§ 371 Date: Mar. 4, 2021

(51) Int. Cl. B41J 2/165

(52) U.S. Cl. CPC B41J 2/16523; B41J 2/16508

(57) ABSTRACT

Disclosed herein is a spittoon cartridge for a printing device, a printing device and a method of controlling a spittoon cartridge. The spittoon cartridge comprises a waste tank to store material ejected from a print head; a transfer unit to transfer material ejected from the print head into the waste tank; and a floater movably arranged in the spittoon cartridge, wherein a position of the floater depends on a filling level of the waste tank and wherein the floater impedes transfer of material by the transfer unit if the floater reaches a predefined warning position.

### BACKGROUND

Printing devices like ink-jet printers may have to be cleaned regularly to maintain image quality and e.g. prevent partial or complete clogging of print head nozzles. To this end, printing devices can comprise a maintenance subsystem to perform cleaning operations on a print head of the printing device.

### BRIEF DESCRIPTION OF DRAWINGS

In the following, a detailed description of various examples is given with reference to the figures. The figures show schematic illustrations of

FIG. 1a: a spittoon cartridge in accordance with an example in side view;

FIG. 1b: the spittoon cartridge of FIG. 1a in top view;

FIG. 2: a spittoon cartridge with a floater that is to mechanically block a spit roller according to an example in side view;

FIG. 3: a spittoon cartridge with a floater that is to mechanically block a gear drive in accordance with an example in a perspective view;

FIG. 4: the floater of the spittoon cartridge of FIG. 3 in a perspective view;

FIG. 5a: the floater and the gear drive of the spittoon cartridge of FIG. 3 in a disengaged state;

FIG. 5b: the floater and the gear drive of the spittoon cartridge of FIG. 3 in an engaged state;

FIG. 6: a printing device with a spittoon cartridge in accordance with an example in top view; and

FIG. 7: a flow chart for an example of a method of controlling a spittoon cartridge.

### DETAILED DESCRIPTION

To clean a print head, a printing device can comprise a spittoon cartridge, into which material can be ejected from the print head nozzles, e.g. to remove material from the nozzles to prevent clogging. The spittoon cartridge can comprise a waste tank to store the ejected material. Over time, the waste tank can fill up and the material may spill, contaminating other parts of the printing device. To prevent this, the filling level of the waste tank can be monitored by estimating the amount of material in the waste tank, e.g. by recording the number of ejection processes or determining the number of drops ejected into the spittoon cartridge. The resulting estimates, however, have a large uncertainty, in particular due to unknown evaporation rates during the ejection and from the waste tank.

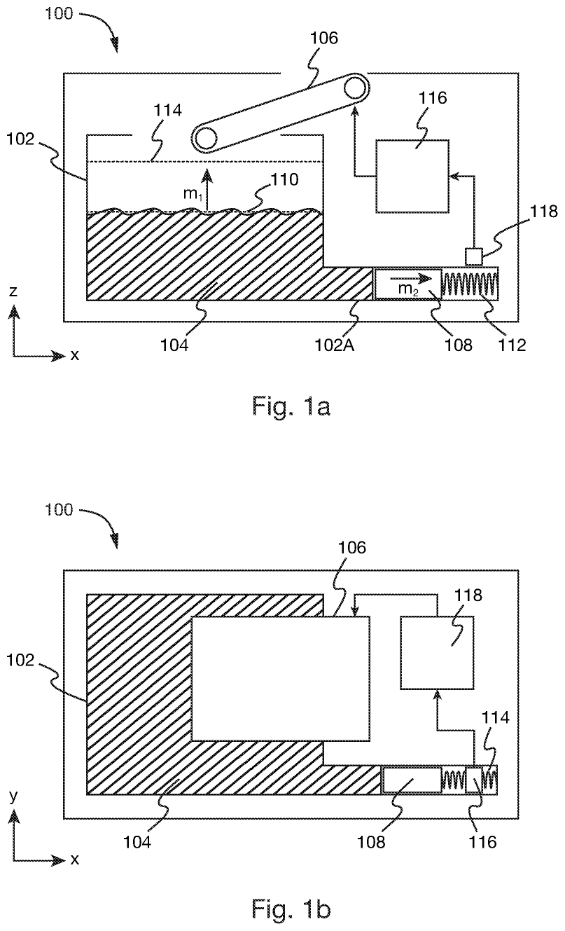

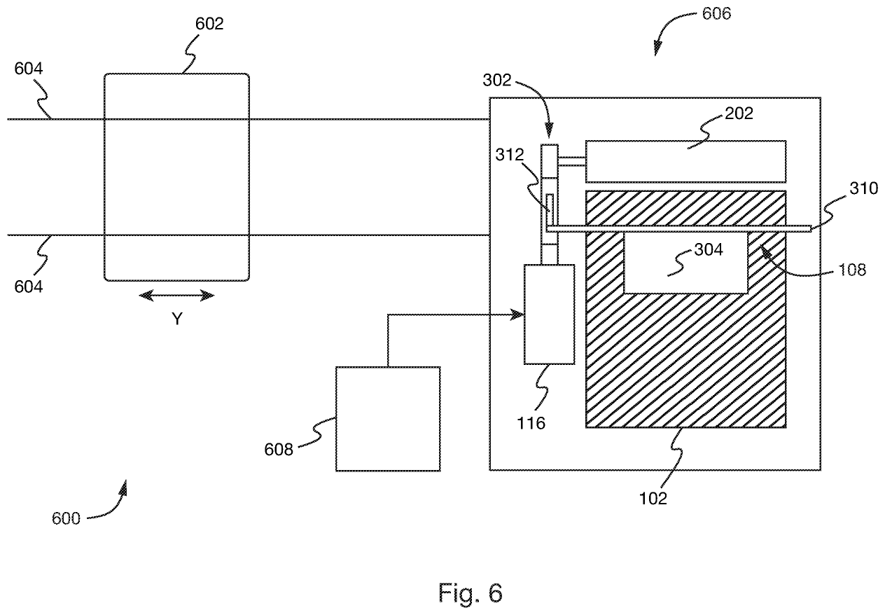

FIGS. 1a and 1b depict an example of a spittoon cartridge 100 in side view and top view, respectively. The spittoon cartridge 100 may for example be employed in a printing device (not shown in FIG. 1a) as detailed below with reference to FIG. 6. A longitudinal direction of the spittoon cartridge 100 is denoted as the X direction in the following, which may e.g. be aligned with a media advance direction in the printing device. A transverse direction of the spittoon cartridge 100 is denoted as the Y direction in the following, which may e.g. be aligned with a scanning direction of a print head of the printing device. The direction perpendicular to the X direction and the Y direction is denoted as the Z direction in the following, which may e.g. be a vertical direction in the printing device, i.e. aligned with the direction of gravity.

The spittoon cartridge 100 comprises a waste tank 102 to store material 104 ejected from a print head. The waste tank 102 may for example have a volume between 5 cm³ and 1000 cm³ or more and may have an opening, e.g. in a top wall or an upper portion of a side wall, to receive the material 104. The waste material 104 may e.g. comprise a printing fluid such as ink or 3D printing material. The spittoon cartridge 100 may further comprise a transfer unit 106 to transfer material ejected from the print head into the waste tank 102. The transfer unit 106 can comprise movable parts and may e.g. comprise a conveyor belt or a rotatable spit roller as detailed below. The transfer unit 106 can for example be arranged above the waste tank 102 in the Z direction such that the print head may be positioned adjacent to the transfer unit 106 to minimize a spit distance between the print head and the transfer unit, e.g. to avoid that aerosol which might be generated when ejecting material from the print head leaks out. The transfer unit 106 may e.g. be arranged adjacent to or in an opening in a top face or cover of the spittoon cartridge 100.

The spittoon cartridge 100 also comprises a floater 108, which is movably arranged in the spittoon cartridge 100. The floater may for example comprise plastic, metal or a combination thereof. A position of the floater 108 depends on a filling level 110 of the waste tank 102. The position of the floater 108 may e.g. be defined as the center of mass of the floater 108 or the position of a predefined point of the floater 108, e.g. a geometric center of the floater 108 or a point on a side, bottom or top surface of the floater 108. The filling level 110 may e.g. be an average height along the Z direction up to which the waste tank 102 is filled with the material 104. In one example, a position of the floater 108 along the X direction depends on the filling level 110, e.g. such that the floater 108 moves to the right along the X direction when the filling level 110 increases as illustrated by the respective arrows m₁ and m₂ in FIG. 1a. Additionally or alternatively, a position of the floater 108 along the Y direction or the Z direction may depend on the filling level 110. In the example shown in FIG. 1a, the floater 108 is arranged in a cavity 102A extending outwards from a main body of the waste tank 102 along the X direction. The cavity 102A may be filled at least partially with the material 104. An increase in the filling level 110 may lead to an increase of the pressure in the material 104 in the cavity 102 A and may thus press the floater 108 outwards along the X direction, e.g. against a flexible element 112 like a spring. In one example, the floater 108 may extend to the outside of the spittoon cartridge 100 at least partially, e.g. such that a change in the position of the floater 108 is visible or can be detected from the outside.

The floater 108 is to impede transfer of material by the transfer unit 106 if the floater 108 reaches a predefined warning position. The floater 108 may further prevent transfer of material by the transfer unit 106 if the floater reaches 108 a predefined threshold position. The predefined threshold position can for example be a position of the floater 108 that corresponds to a threshold filling level 114 of the waste tank 102. The threshold filling level 114 may e.g. be a filling level of the waste tank 102 below which there is no risk of spilling material from the waste tank 102 under normal or close to normal operating conditions. The predefined warning level may for example be the position of the floater 108 corresponding to a warning filling level of the waste tank 102, e.g. to indicate that the spittoon cartridge may have to be replaced or emptied soon. The warning filling level may be lower than the threshold filling level 114, for example a certain fraction of the threshold filling, e.g. 90% of the threshold filling level 114. Preventing transfer of material by the transfer unit 106 refers to preventing operation of the transfer unit 106 such that there is no active transfer of material into the waste tank 102 by the transfer unit 106. In some examples, there may still be passive transfer of material, e.g. printing fluid ejected onto the transfer unit 106 that passes into the waste tank 102 by itself without operation of the transfer unit 106.

The transfer unit 106 may be coupled to an actuator 116, e.g. an electric motor, to move moveable parts of the transfer unit 106. The floater 108 reaching the predefined warning position may for example impede transfer of material by the transfer unit 106 by changing an electric drive signal for the actuator 116 or by triggering a warning signal for the actuator 116 if the floater 108 reaches the predefined warning position, e.g. by opening or closing an electric circuit. Accordingly, the floater 108 reaching the predefined threshold position may for example prevent transfer of material by the transfer unit 106 by interrupting an electric drive signal for the actuator 116 or by triggering an interrupt signal for the actuator 116 if the floater 108 reaches the predefined threshold position, e.g. by opening or closing an electric circuit. The spittoon cartridge 100 may also comprise a sensor 118 to detect whether the floater 108 has reached the predefined warning or threshold position, e.g. a contact sensor or a proximity sensor like a capacitive sensor, a magnetic field sensor or a photoelectric sensor. The sensor 118 may e.g. change or interrupt the electric drive signal for the actuator 116 or trigger the warning or interrupt signal for the actuator 116.

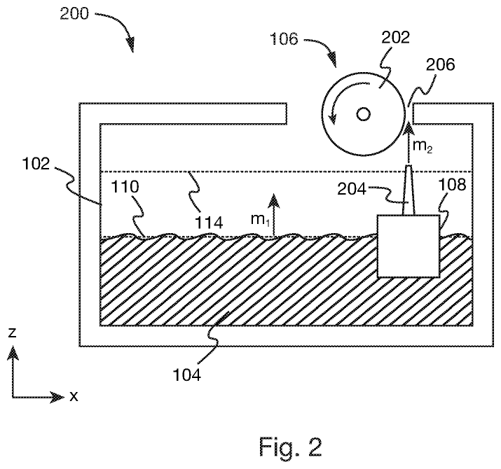

In other examples, the floater 108 may mechanically engage an element of the transfer unit 106 or of the actuator 116 or a coupling element coupling the transfer unit 106 to the actuator 116, e.g. a gear drive or drive belt, to impede or prevent transfer of material by the transfer unit 106. The floater 108 can for example impede the transfer of material by the transfer unit 106 by increasing a load of the actuator 116, e.g. by generating a friction force. The floater 108 may e.g. mechanically impede or block the movement of the respective element as detailed below with reference to FIGS. 2, 3, 4a and 4b. In this example, the floater 108 reaching the predefined warning or threshold position and impeding or preventing transfer of material by the transfer unit 106 may be based entirely on mechanical interaction.

FIG. 2 illustrates another example of a spittoon cartridge 200 in side view. Similar to the spittoon cartridge 100, the spittoon cartridge 200 also comprises a waste tank 102 to store material 104, a transfer unit 106 to transfer material into the waste tank 102 and a floater 108. The transfer unit 106 comprises a spit roller 202. The spit roller 202 may for example be a rotatably mounted rod or cylinder and may be coupled to an actuator to rotate the spit roller 202. The spit roller 202 may e.g. be arranged in an opening in a top face or cover of the spittoon cartridge 200 to receive material ejected from a print head placed adjacent to the spit roller 202. By rotating the spit roller 202, material ejected onto the spit roller 202 may be transferred to the waste tank 102, which may e.g. be arranged underneath the spit roller 202.

In the spittoon cartridge 200, the floater 108 is movably arranged in the waste tank 102 to float on the material 104 contained in the waste tank. The floater 108 may e.g. comprise a material with a lower density than the material 104 or may comprise a recess or a cavity such that an average density of the floater 108 is lower than the density of the material 104. The floater 108 is to mechanically impede or block the rotation of the spit roller 202 if the floater reaches a predefined warning or threshold level corresponding to a predefined warning or threshold position.

The floater 108 may for example comprise a blocking element 204, e.g. a protrusion or an arm, that enters a gap 206 between the spit roller 202 and a wall of the waste tank 102 or spittoon cartridge 200 as the filling level of the waste tank 102 increases as illustrated by the respective arrows m₁ and m₂ in FIG. 2. The blocking element 204 may come in contact with the spit roller 202 when the floater 108 reaches the predefined warning level. This may lead to an increased friction that impedes the rotation of the spit roller 202 without completely blocking the rotation. The friction may increase gradually as the floater 108 approaches the predefined threshold level and may e.g. exceed a driving force generated by an actuator when the floater 108 reaches the predefined threshold level, thereby blocking the rotation of the spit roller 202. A shape of the blocking element 204 may be adapted to a shape of the gap 206 such that blocking element 204 mechanically blocks the rotation of the spit roller 202 if the floater reaches the predefined threshold level, e.g. by coming in contact with both the spit roller 202 and the wall. To ensure that the blocking element 204 is aligned with the opening 206, the movement of the floater 108 may be constrained along the X direction, e.g. using a guiding groove in a side wall of the waste tank 102.

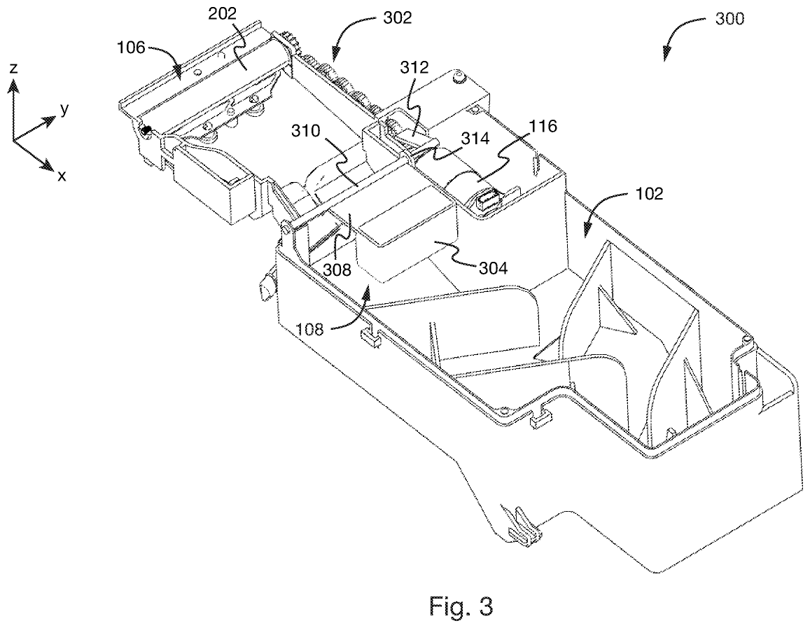

In FIG. 3, another example of a spittoon cartridge 300 is shown in a perspective view. The spittoon cartridge 300 comprises a waste tank 102 to store material 104 (not shown in FIG. 3), a transfer unit 106 having a spit roller 202 and a floater 108. The spittoon cartridge 300 further comprises an actuator 116, which is coupled to the transfer unit 106 via a gear drive 302, wherein the gear drive 302 may comprise a plurality of cog wheels.

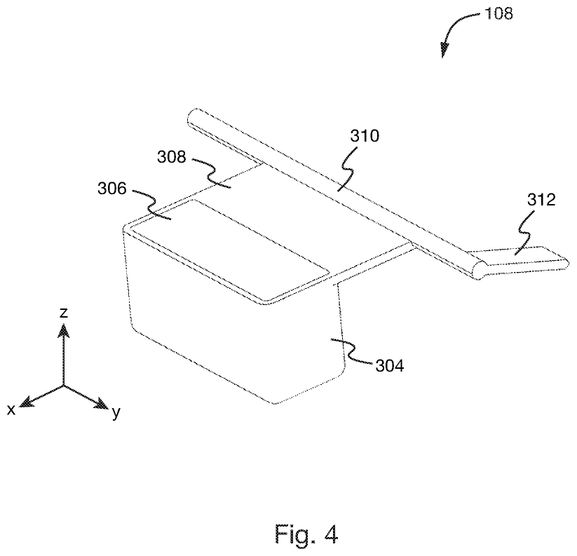

FIG. 4 shows a perspective view of the floater 108 of the spittoon cartridge 300 according to an example. The floater 108 comprises a main body 304, which is movably arranged in the waste tank 102 to float on the material 104 contained in the waste tank 102. The main body 304 may e.g. have a cuboid or approximately cuboid shape. The main body 304 may e.g. comprise a material with a lower density than the material 104 or may comprise a cavity or a recess 306 such that an average density of the floater 108 is lower than the density of the material 104. The floater 108 further comprises an arm having a front portion 308, a center portion 310 and an end portion 312, wherein the front portion 308 is connected to the main body 308. The arm may be attached to the main body 304 or may be integrally formed with the main body 304. The front portion 308 may for example have a rectangular or approximately rectangular shape and may e.g. be an extension of a top face of the main body 304.

The center portion 310 of the arm is pivotally connected to a bearing point 314 of the spittoon cartridge such that the floater 108 can pivot or rotate around a rotation axis through the bearing point 314. The center portion 310 may e.g. have a cylindrical shape extending along a direction perpendicular or approximately perpendicular to the vector connecting the center portion 310 to the main body 304. A longitudinal axis of the center portion 310 may e.g. be the rotation axis of the floater 108. The bearing point 314 may for example be a groove or recess on top of a side wall of the waste tank 102, in which the center portion is arranged. In another example, the bearing point 314 may be a hole or cut-out in a side wall of the waste tank 102, which encloses the center portion 310 as illustrated in FIG. 3.

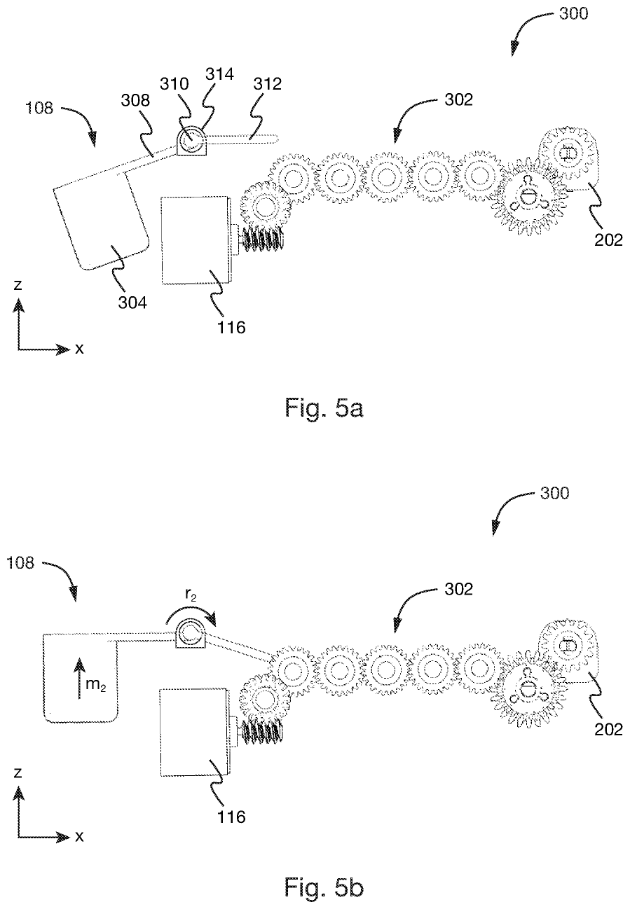

The end portion 312 of the arm is arranged such that the end portion 312 mechanically impedes the gear drive 302 coupled to the transfer unit 106 if the main body 304 reaches the predefined warning level. This is illustrated in FIGS. 5a and 5b and explained in more detail below. The end portion 312 may further mechanically block the gear drive 302 if the main body 304 reaches the predefined threshold level. The end portion 312 may for example be a protrusion, e.g. a rectangular or approximately rectangular protrusion, extending from the center portion 310 in a direction away from the main body 304, e.g. such that the front portion 308 and the end portion 312 enclose an angle between 90° and 270° as seen in side view. The end portion 312 may for example be arranged such that the end portion 312 and the main body 304 move in opposite or approximately opposite directions when the floater 108 rotates around the rotation axis through the bearing point 314. In one example, the end portion 312 may be connected to a side part of the center portion 310 that is located on the other side of the bearing point 314 as a part of the center portion 310 connected to the front part 308.

FIGS. 5a and 5b show a side view of the floater 108 and the gear drive 302 of the spittoon cartridge 300. FIG. 5a depicts a situation, in which the floater 108 has not reached the predefined warning level, e.g. because the filling level of the waste tank 102 is lower than a warning filling level. FIG. 5b depicts a situation, in which the floater has reached the predefined warning level, e.g. because the filling level of the waste tank 102 is at or above the warning filling level. Since the main body 304 of the floater 108 in the spittoon cartridge 300 floats on the material 104 in the waste tank 102, the position of the main body 304 along the Z direction rises with a rising filling level of the waste tank 102. As the material 104 presses the main body 304 upwards, the floater 108 rotates around the rotation axis through the bearing point 314 as illustrated by the respective arrows m₂ and r₂ in FIG. 5b. Accordingly, the end portion 312 is lowered and moves closer to the gear drive 302. When the main body 304 reaches the predefined warning level, the end portion 312 mechanically engages the gear drive 302, e.g. a cog wheel of the gear drive 302, and impedes the gear drive 302, e.g. by impeding the rotation of the cog wheel. Thereby, the transfer of material by the transfer unit 106 is impeded. When the main body 304 rises further and reaches the predefined threshold level, the end portion 312 may mechanically block the gear drive 302, e.g. by preventing the cog wheel from rotating. Thereby, the transfer of material by the transfer unit 106 is prevented as the actuator 116 can no longer drive the transfer unit 106. Blocking the gear drive 302 may block the actuator 116 as well. In some examples, the floater 108 may not rotate continuously, but may exhibit a discrete number of stable configurations or orientations, wherein each transition between configurations may require a certain torque, e.g. a certain buoyancy acting on the main body 304, in order for the floater 108 to go from a given configuration to the next. The floater 108 may for example have two stable configurations, a disengaged state in which the floater 108 does not engage the gear drive 302 and an engaged state in which the floater 108 engages the gear drive 302. The floater 108 may remain in the disengaged state until the torque generated by the buoyancy of the main body 304 in the waste material 104 exceeds a certain threshold when the filling level 110 reaches the warning filling level. At this point, the floater 108 may transition to the engaged state.

In other examples, the configuration may differ from the one shown in FIGS. 5a and 5b. For example, the point at which the end portion 312 mechanically engages the gear drive 302 may be different. Alternatively, the end portion 312 may directly engage the actuator 116 or the spit roller 202. The end portion 312 may comprise a rotary damper, wherein the rotary damper engages the gear drive 302, the actuator 116 or the spit roller 202 to create an additional resistance. The rotary damper may for example comprise a rotatable cog wheel to engage the respective element and the cog wheel may be coupled to a static element through a layer of a viscous fluid that generates a brake force when the cog wheel rotates. In one example, the gear drive 302 may be arranged above the floater 108 and the floater 108 may comprise a blocking element 204, e.g. arranged on the main body 304, instead of the end portion 312, wherein the blocking element 204 engages the gear drive 302 as the floater 108 rotates around the rotation axis. Alternatively, the floater 108 may be similar to the one shown in FIG. 2 and may e.g. be arranged in a guiding groove in a side wall of the waste tank 102 to move along the Z direction instead of rotating around the bearing point 314. In yet another example, the end portion 312 may be connected to a center part of the center portion 310 that is located on the same side of the bearing point 314 as a part of the center portion 310 connected to the front part 308. Furthermore, a different coupling element between the actuator 116 and the spit roller 202 may be used, e.g. a drive belt, wherein the floater 108 engages the drive belt to mechanically block the drive belt.

FIG. 6 depicts a printing device 600 in accordance with an example in top view. The printing device 600 comprises a print head 602, e.g. an ink-jet print head having a reservoir for a printing fluid such as ink and a nozzle plate for depositing the printing fluid on a print medium. The print head 602 can be movable along a print head path 604 in a scanning direction, which may e.g. be aligned with the Y direction and is illustrated by the arrow labeled “Y” in FIG. 6. The scanning direction may e.g. be perpendicular to a direction of movement of the print medium, also referred to as media advance direction. The media advance direction may be aligned with the X direction. In other examples, the printing device 600 may be a 3D printer and the print head 602 may be moveable in multiple directions. The printing device 600 may comprise an actuator for moving the print head 602 along the print head path 604, for example an electric motor coupled to a carriage carrying the print head 602 via a drive belt or a gear drive such as a worm drive.

The printing device 600 comprises a spittoon cartridge 606, which can e.g. be similar to one of the spittoon cartridges 100, 200 or 300 and comprises a waste tank 102, a rotatable spit roller 202 and a floater 108. The position of the floater 108 depends on a filling level of the waste tank 102 and the floater 108 impedes rotation of the spit roller 202 if the floater 108 reaches a predefined warning level or position, e.g. as described above with reference to FIGS. 1, 2, 5a and 5b. The floater 108 may further prevent rotation of the spit roller 202 if the floater 108 reaches a predefined threshold level or position. The spittoon cartridge 606 can be arranged in a maintenance zone of the printing device 600, which may e.g. be adjacent to an end point of the print head path 604. The spittoon cartridge 606 may be arranged such that a nozzle plate of the print heat 604 is located above the spit roller 202 of the spittoon cartridge 606 as seen in the direction of view in FIG. 6 when the print head 602 is moved to the maintenance zone. In one example, the spittoon cartridge 606 may be at a fixed position in the printing device 600, whereas in other examples, the spittoon cartridge 606 may be moveable within the printing device 600. To move the spittoon cartridge 606, the printing device 600 may further comprise an actuator, e.g. an electric motor coupled to the spittoon cartridge 606 via a drive belt or a gear drive such as a worm drive. In some examples, the spittoon cartridge 606 may be a subsystem of a maintenance cartridge that also comprises other subsystems for cleaning the print head 602, e.g. a wiping subsystem for wiping the print head 602 and a capping subsystem for covering a nozzle plate of the print head 602.

The printing device 600 further comprises a blockage detector 608 to detect if the rotation of the spit roller 202 is impeded. The blockage detector 608 may also detect if the rotation of the spit roller 202 is prevented. In one example, the blockage detector 608 may be connected to a sensor to detect if the rotation of the spit roller 202 is impeded or prevented, e.g. an inductive or magnetic sensor or a rotary encoder that detects how fast or whether the spit roller 202 rotates. The blockage detector 608 may for example determine a revolution speed of the spit roller 202 and compare the determined revolution speed to an expected revolution speed. Alternatively, the blockage detector 608 may be connected to a sensor, e.g. the sensor 118, to detect whether the floater 108 has reached the predefined warning or threshold level and thus impedes or prevents the rotation of the spit roller 202.

In the example shown in FIG. 6, the blockage detector 608 is connected to an actuator 116 that is coupled to the spit roller 202, e.g. via the gear drive 302, to monitor an electric signal of the actuator 116, e.g. a motor current, a motor voltage or an electric sensor signal of a sensor in the actuator 116, e.g. an inductive or magnetic sensor or an encoder. The blockage detector 608 may detect if the rotation of the spit roller 202 is impeded or prevented by detecting from the electric signal whether movement of the actuator 116 is impeded or blocked. The blockage detector 608 may e.g. detect a change of a load of the actuator 116 by monitoring the electric signal of the actuator. For example, the blockage detector 608 may detect that there is an unexpected rise in motor current or voltage or change in sensor or encoder signal which may be an indication of an impeded or blocked actuator. This may e.g. be the case when the floater 108 mechanically impedes or blocks the rotation of the spit roller 202 or the gear drive 302. Alternatively, the blockage detector 608 may detect whether an electric drive signal for the actuator 116 is changed or interrupted or a warning or interrupt signal for the actuator 116 is triggered. The blockage detector 608 may further determine quantitatively how strongly the rotation of the spit roller 202 is impeded, e.g. by determining the load of the actuator 116 from the electric signal.

The blockage detector 608 may be part of a controller that controls the actuator 116, e.g. by sending drive commands to the actuator 406 or by providing a suitable electric drive signal, e.g. a pulse-width modulated drive voltage. The actuator 116 may be part of the spittoon cartridge 606, e.g. as in the spittoon cartridge 300. In other examples, the actuator 116 may be outside of the spittoon cartridge 606, e.g. attached to a chassis or frame of the printing device 600, and may e.g. be coupled to the spit roller 202 or the gear drive 302 via a drive belt. The actuator 116 may also be used for moving the spittoon cartridge 606 or a maintenance cartridge comprising the spittoon cartridge 606.

When the blockage detector 608 detects that the rotation of the spit roller 202 is impeded or blocked, the printing device 600 can enter an error state. The printing device 600 may remain in the error state as long as the rotation of the spit roller 202 is impeded or blocked, e.g. until the spittoon cartridge 606 has been replaced or emptied. In the error state, the printing device 600 may refrain from ejecting additional material into the spittoon cartridge 606, e.g. to avoid spilling of material from the waste tank 102. If the spittoon cartridge 606 is movable, the printing device 600 may move the spittoon cartridge 606 to a servicing position, e.g. a position, in which the spittoon cartridge 606 can be accessed by a user. The printing device 600 may further interrupt a current printing job, when the printing device 600 enters the error state, or may delay future printing jobs until the rotation of the spit roller 202 is no longer impeded or prevented, e.g. after the spittoon cartridge 606 has been replaced or emptied. In one example, the printing device 600 may comprise a second spittoon cartridge, e.g. adjacent to an opposing end of the print head path 604. In the error state, the printing device 600 may eject material into the second spittoon cartridge instead of the spittoon cartridge 606.

The printing device 600 may further generate an error signal if the printing device is in the error state. The error signal may e.g. comprise switching on an indicator light on the printing device 600, e.g. a light-emitting diode with a corresponding label, displaying an error message on a display of the printing device 600, generating an audio warning and/or sending an error message to a control device of the printing device 600, e.g. a computer connected to the printing device 600.

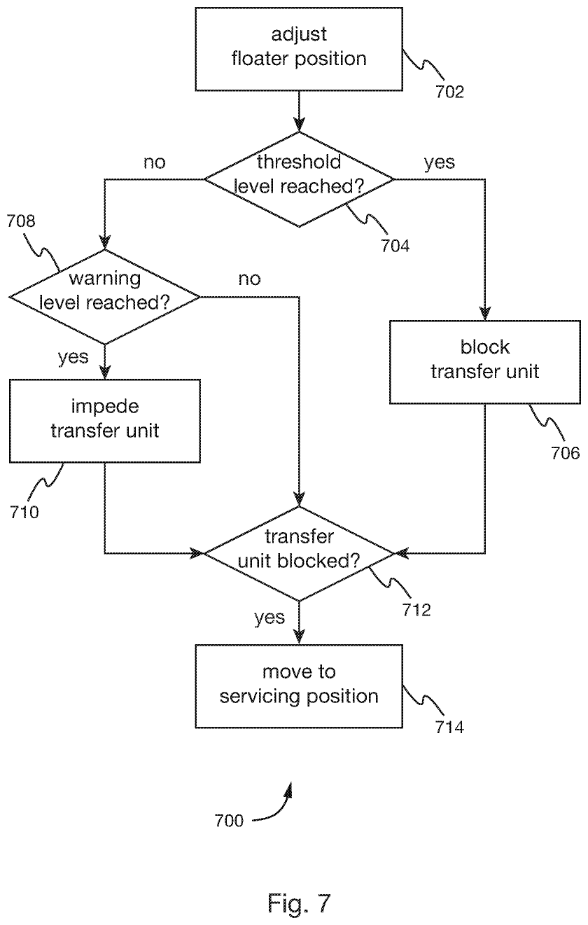

FIG. 7 shows a flow chart of a method 700 of controlling a spittoon cartridge according to an example. The method 700 may for example be performed with the printing device 600 and will be described in the following with reference to FIG. 6. This is, however, not intended to be limiting in any way. The method 700 may be executed with any suitable printing device or spittoon cartridge comprising a waste tank, a transfer unit and a floater, such as the spittoon cartridges 100, 200, and 300. The method 700 may for example be executed as part of a startup process or a cleaning routine of the printing device 600. In one example, the method 700 may be executed each time material is ejected into the spittoon cartridge 606 or each time the filling level 110 of the waste tank 102 changes.

In 702, a position of the floater 108 is adjusted to the filling level 110 of the waste tank 102. The position of the floater 108 may for example be adjusted based on a predefined correspondence between the position of the floater 108 and the filling level 110, i.e. the floater 108 may be moved to the position that is associated with the current filling level 110. The position of the floater 108 may e.g. be the center of mass of the floater 108 or the position of a predefined point of the floater 108, e.g. a geometric center of the floater 108 or a point on a bottom or top surface of the floater 108. In one example, a position of the floater 108 along the X direction may be adjusted to the filling level 110, e.g. as illustrated in FIG. 1a. The position of the floater 108 may e.g. be adjusted such that the position along the X direction depends linearly on the filling level. Additionally or alternatively, a position of the floater 108 along the Y direction or the Z direction may be adjusted to the filling level 110. For example, if the floater 108 is movably arranged in the waste tank 102 to float on the material 104 as for the spittoon cartridges 200 and 300, the position of the floater 108 along the Z direction may be adjusted such that the position is equal to or approximately equal to the filling level.

The method 700 may further comprise determining, in 704, whether the floater 108 has reached a predefined threshold level, i.e. whether the position of the floater 108 is equal to or exceeds the predefined threshold level. For this, a sensor like the sensor 118 may be used. In some examples, this may comprise determining the position of the floater 108.

If the floater 108 has reached the predefined threshold level, the operation of the transfer unit 106 may be prevented in 706, e.g. by preventing active transfer of material into the waste tank 102 by the transfer unit 106. This may for example comprise mechanically blocking, e.g. with the floater 108, the transfer unit 106, a component thereof like the spit roller 202 or an element coupled to the transfer unit 106, e.g. the gear drive 302. In other examples, this may comprise generating an interrupt command or interrupt trigger signal for an actuator coupled to the transfer unit 106, e.g. the actuator 116, or interrupting an electric drive signal of the actuator.

The method 700 may further comprise determining, in 708, whether the floater 108 has reached a predefined warning level, e.g. in case the floater 108 has not reached the predefined threshold level. The floater 108 has reached the predefined warning level when the position of the floater 108 is equal to or exceeds the predefined warning level. As in 704, a sensor like the sensor 118 may be used for this and in some examples 708 may comprise determining the position of the floater 108 or using a position of the floater 108 determined previously, e.g. in 704.

If the floater 108 has reached the predefined warning level, the operation of the transfer unit 106 is impeded in 706, for example by increasing a load of an actuator coupled to the transfer unit 106. For this, the floater 108 may be brought in contact with the transfer unit 106, a component thereof like the spit roller 202 or an element coupled to the transfer unit 106, e.g. the gear drive 302, in order to generate a friction force. Alternatively, this may comprise generating a warning command or warning trigger signal for an actuator coupled to the transfer unit 106, e.g. the actuator 116, or changing an electric drive signal of the actuator. In one example, the load of the actuator may be increased gradually the further the position of the floater 108 exceeds the predefined warning level or the closer the position of the floater 108 is to the predefined threshold level. If the floater 108 has not reached the predefined warning level, the method 700 may proceed to 712.

The method 700 may comprise, in 712, detecting whether operation of the transfer unit 106 is impeded or prevented. As described above with reference to FIG. 6, this may comprise reading out an electric signal of an actuator coupled to the transfer unit 106, e.g. the actuator 116, wherein the electric signal may e.g. be a motor current, a motor voltage or an electric sensor signal of a sensor in the actuator 116, e.g. an inductive or magnetic sensor or a rotary encoder. The electric signal may be used to detect whether operation of the transfer unit 106 is impeded or prevented, e.g. by detecting an increase, decrease or change in the shape of the electric signal that is associated with an increased load or a mechanical blockade of the actuator. In one example, 712 may comprise quantifying how strongly operation of the transfer unit 106 is impeded, e.g. by determining a load of the actuator 116. In other examples, 712 may comprise determining whether a moveable element of the transfer unit 106, e.g. the spit roller 202, moves or whether the floater 108 has reached the predefined warning or threshold level.

If operation of the transfer unit 106 is impeded or prevented, the spittoon cartridge 606 may be moved to a servicing position in 706 and/or 710, e.g. a position, in which the spittoon cartridge 606 can be accessed by a user. 706 and/or 710 may further comprise setting the printing device 600 to an error state and/or generating an error signal, e.g. as described above.

The method 700 may be executed and modified in various ways. As far as technically feasible, the method 700 may be performed in any order and different parts may be performed simultaneously at least in part. For example, the position of the floater 108 may be adjusted continuously in 702 throughout execution of the entire method 700, e.g. by using a floater 108 that is movably arranged to float on the material 104 in the waste tank. Furthermore, impeding or preventing operation of the transfer unit 106 in 706 and 710, respectively, may be performed simultaneously at least in part with the adjustment of the position of the floater 108 in 702, e.g. with the spittoon cartridge 200 or 300, for which an adjustment of the position of the floater 108 may cause the blocking element 204 or the end portion 312 of the arm of the floater 108 to mechanically engage the spit roller 202 and the gear drive 302, respectively, thereby impeding or preventing operation of the transfer unit 106.

This description is not intended to be exhaustive or limiting to any of the examples described above. The print head maintenance assembly, printing device and method disclosed herein can be implemented in various ways and with many modifications without altering the underlying basic properties.

1. A spittoon cartridge for a printing device, the spittoon cartridge comprising:
a waste tank to store material ejected from a print head;
a transfer unit to transfer material ejected from the print head into the waste tank; and
a floater movably arranged in the spittoon cartridge, wherein a position of the floater depends on a filling level of the waste tank and wherein the floater impedes transfer of material by the transfer unit if the floater reaches a predefined warning position.

2. The spittoon cartridge of claim 1, wherein the floater prevents transfer of material by the transfer unit if the floater reaches a predefined threshold position.

3. The spittoon cartridge of claim 1, wherein the transfer unit comprises a spit roller.

4. The spittoon cartridge of claim 3, wherein the floater mechanically impedes the rotation of the spit roller if the floater reaches the predefined warning position.

5. The spittoon cartridge of claim 1, wherein the floater is movably arranged in the waste tank to float on the material contained in the waste tank.

6. The spittoon cartridge of claim 5, wherein the floater comprises a main body and an arm connected to the main body, a center portion of the arm pivotally connected to a bearing point and an end portion of the arm arranged such that the end portion mechanically impedes a gear drive coupled to the transfer unit if the main body reaches the predefined warning position.

7. A printing device comprising:
a print head;
a spittoon cartridge comprising a waste tank, a rotatable spit roller and a floater, wherein a position of the floater depends on a filling level of the waste tank and wherein the floater impedes the rotation of the spit roller if the floater reaches a predefined warning position; and
a blockage detector to detect if the rotation of the spit roller is impeded.

8. The printing device of claim 7, wherein
the spittoon cartridge further comprises an actuator coupled to the spit roller to rotate the spit roller;
the floater mechanically impedes the rotation of the spit roller; and
the blockage detector is to detect a change of a load of the actuator by monitoring an electric signal of the actuator.

9. The printing device of claim 7, wherein the floater is to prevent the rotation of the spit roller if the floater reaches a predefined threshold position and the blockage detector is to detect if the rotation of the spit roller is prevented.

10. The printing device of claim 9, wherein the printing device enters an error state if the blockage detector detects that the rotation of the spit roller is prevented.

11. The printing device of claim 10, wherein the printing device generates an error signal if the printing device is in the error state.

12. A method of controlling a spittoon cartridge, wherein the spittoon cartridge comprises a waste tank, a transfer unit, and a floater, the method comprising:
adjusting a position of the floater to a filling level of the waste tank; and
impeding the operation of the transfer unit if the floater reaches a predefined warning position.

13. The method of claim 12, further comprising detecting whether operation of the transfer unit is impeded.

14. The method of claim 12, further comprising preventing operation of the transfer unit if the floater reaches a predefined threshold level.

15. The method of claim 14, further comprising moving the spittoon cartridge to a servicing position if operation of the transfer unit is prevented.
